(19) United States
(12) Patent Application Publication
(10) Pub. No.: US 2019/0069523 A1
(43) Pub. Date: Mar. 7, 2019

(54) Anti-Pull Leash

(71) Applicant: Daniel Peterson, Chicago, IL (US)

(72) Inventor: Daniel Peterson, Chicago, IL (US)

(21) Appl. No.: 15/967,057

(22) Filed: Apr. 30, 2018

Related U.S. Application Data
(62) Division of application No. 14/591,271, filed on Jan. 7, 2015, now abandoned.
(60) Provisional application No. 61/924,443, filed on Jan. 7, 2014.

(51) Int. Cl. A01K 27/00

(52) U.S. Cl. CPC A01K 27/003; A01K 27/002

(57) ABSTRACT

A leash for an animal is provided that includes a collar end and a handle end positioned opposite the collar end. An intermediate portion of the leash is located between the collar end and the handle end of the leash. The intermediate portion includes two separate strands wherein a first end of each strand is attached at the collar end of the leash and a second end of each strand is attached at the handle end of the leash. The leash is configured to encircle the abdomen of the animal by passing the handle end of the leash through a loop formed between the two separate strands such that the leash forms a constrictive loop around the animal's midsection or abdomen, specifically the portion of the animal's torso located between animal's hind legs and the animal's ribs. Methods for using the leash are also disclosed.

### RELATED APPLICATION(S)

This application is a division of U.S. application Ser. No. 14/591,271 filed Jan. 7, 2015, which claims the benefit of U.S. Provisional application No. 61/924,443 filed Jan. 7, 2014, both of which applications are incorporated by reference in their entirety herein.

### TECHNICAL FIELD

The invention relates generally to a device for restraining an animal, specifically a leash designed to discourage the animal from pulling.

### BACKGROUND

Numerous devices and mechanisms have attempted to control dogs and other animals when they are walked on a leash. The problem of pulling is particularly common in large breeds of dogs, and many devices and mechanisms have attempted to discourage dogs from pulling when they are walked on a leash. Existing mechanisms commonly operate to choke or pinch the dog, typically by using a collar around the dog's neck. While this approach may eventually work to subdue a dog, it is frequently ineffective as a training device. Many dogs become immune to the effect of such choke or pinch collars. Further, collars in general do not provide good leverage because the collar attaches close to the shoulder region of the dog, near the center of the dog's mass. Because of this, the dog is able to plant its forepaws to oppose any pulling force exerted on the leash. In addition, because the collar is typically free to rotate around the dog's neck, it centers itself in opposition to the force exerted by the dog, and the dog naturally maintains its balance when it pulls against such a collar. Above and beyond the shortcomings of such choke and pinch collars, many dog owners object to these types of collars because they worry about the humaneness of a device that constricts their dog's airway.

Alternative approaches to controlling an animal typically require complicated harness systems, in which the animal must step in or be snapped in to the harness. These systems are frequently difficult to put on the animal, particularly in the case of young or especially energetic dogs. The difficulty of using such harnesses is compounded because each harness assembles and snaps together uniquely—often in a way that is different from other harnesses. Each harness therefore requires a unique approach for assembly. In addition, individual animals may prefer certain approaches for putting the harness on. For example, some dogs prefer not to put the harness over their head, while other dogs will prefer not to step in to the harness. Such harnesses therefore require a substantial amount of time for both the person and the animal to become familiar with the process for putting the harness on. The frequent result is that anyone unfamiliar with such a harness will be unable to use the harness because the dog will not cooperate or because the harness becomes tangled and impossible to understand. In this situation, the harness may be rendered useless because the unfamiliar user may not have any alternative way to attach a leash to the dog.

Even beyond the difficulties related to assembling harness systems, the known harnesses often fail to restrain a dog that is intent upon pulling at its leash. Harnesses typically do not constrict in response to pulling and therefore will not work to subdue the dog in the same way as a choke or pinch collar. Even in harness systems that have been designed to constrict, the constriction typically happens in the chest area of the dog and is not effective at stopping the dog from pulling against the harness. Further, such harnesses typically do not provide good leverage because the leash typically attaches to the harness above the dog's shoulders or at the dog's chest. As with most choke or pinch collars, this places the leash connection at the center of the dog's mass. When a dog has committed to pull against its leash it simply plants its forepaws to oppose any pulling force exerted on the leash. This allows the dog to maintain its natural balance when it pulls against a leash attached to such a harness.

### SUMMARY

Generally speaking and pursuant to these various embodiments, a leash for an animal is provided that includes a collar end and a handle end positioned opposite the collar end. The collar end of the leash further includes a mechanism located for attaching the leash to a collar on the neck of the animal. An intermediate portion of the leash is located between the collar end and the handle end. The intermediate portion includes two separate strands wherein a first end of each strand is attached at the collar end of the leash and a second end of each strand is attached at the handle end of the leash. The leash is configured to encircle the abdomen of the animal by passing the handle end of the leash through a loop formed between the two separate strands such that the leash forms a constrictive loop around the animal's midsection or abdomen, specifically the portion of the animal's torso located between animal's hind legs and the animal's ribs.

The length of the intermediate portion of the leash is designed to allow the handle end of the leash to pass through the two strands that make up the intermediate portion. In some examples, the intermediate portion is positioned along the length of the leash substantially adjacent to the animal's abdomen, although the overall length of the intermediate portion may extend beyond the animal's abdomen depending upon the size of the animal.

Because the leash constricts the animal's abdomen, it exerts control over the animal that is not available through most known leashes that constrict or pinch the animal's neck or chest area. Dogs, in particular, become uncomfortable when their abdomen is constricted in this fashion. Use of this type of mechanism greatly improves control over the leashed animal and acts as an effective training tool. Dogs, in particular, quickly learn not to pull on the disclosed leash because they dislike the constrictive pressure exerted by the leash on their midsection.

Further, because the leash anchors to the animal's abdomen, it provides greater leverage over the animal. In contrast to most known leashes, which anchor to the animal in the neck, chest, or shoulder region of the animal's body, the leash described here anchors to a point on the animal's body that is away from the animal's center of mass. Most animals have a harder time exerting a force opposed to the pulling motion of a leash anchored to their hind section. Dogs, in particular, are less able to plant their hind paws to oppose pulling force exerted on the leash. Accordingly, a person holding the disclosed leash typically needs to exert less force to control the animal.

### BRIEF DESCRIPTION OF THE DRAWINGS

The above needs are at least partially met through provision of a leash described in the following detailed description, particularly when studied in conjunction with the drawings, wherein:

FIG. 1 comprises a side view of a leash in use on a dog as configured in accordance with various embodiments of the invention;

FIG. 2 comprises a top view of a leash in use on a dog as configured in accordance with various embodiments of the invention;

FIG. 3 comprises a side view of one example of a leash as configured in accordance with various embodiments of the invention;

FIG. 4 comprises a side view of one example of a leash as configured in accordance with various embodiments of the invention;

FIG. 5 comprises a side view of one example of a leash as configured in accordance with various embodiments of the invention;

FIG. 6 comprises a side view of one example of a leash as configured in accordance with various embodiments of the invention;

FIG. 7 comprises a top view of one example of a leash as configured in accordance with various embodiments of the invention.

FIG. 8 comprises a top view of another example of a leash as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. Common numbers are used across the various drawings to illustrate similar or identical features. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

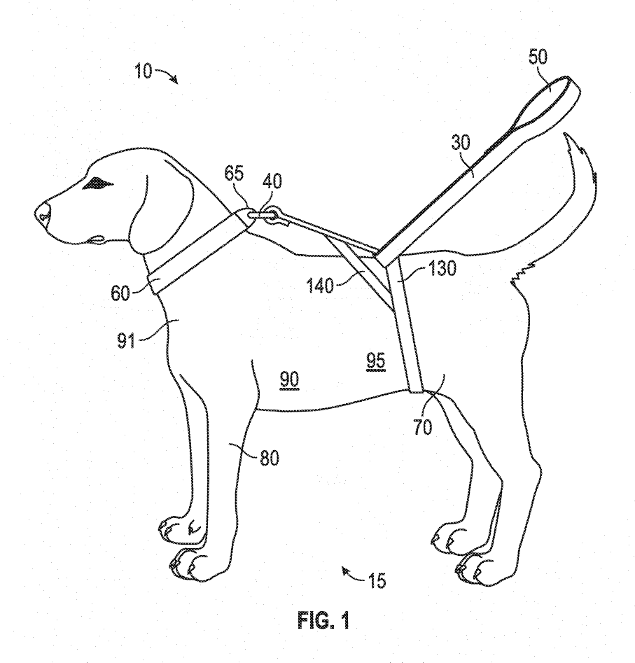

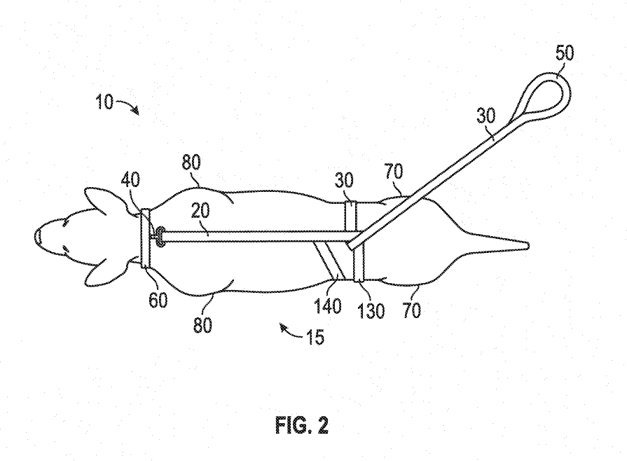

In one example, as illustrated in FIGS. 1 and 2, a leash 10 is designed to loop around the mid-section of an animal 15. The leash 10 may be constructed from a variety of naturally occurring or synthetic materials. Leather straps may be used, or the leash may be constructed from a variety of woven webs or flat tubing made from natural fibers or nylon, polypropylene, or polyester. The leash 10 may be constructed in whole or in part from an elastic material such that the leash stretches when pulled upon. In a preferred embodiment, the leash is constructed from a one inch wide woven web. The leash 10 must be rigid enough to remain in place on the dog 15, while also being flexible enough to maintain the comfort of the dog and to wrap easily around the dog 15. In one example, the material used for different portions of the leash might be different, to maintain the correct amount of flexibility for each segment of the leash.

The leash could be used with many types of animals. In a preferred embodiment described herein the leash is used with a dog 15. The dog has hind legs 70, front legs 80, a chest 90, and an abdomen 95. The leash wraps around the dog's abdomen 95, located immediately in front of the dog's hind legs 70 and behind the dog's ribs. The illustrated leash has a quick release latch or hook 40 that attaches to the dog's collar 60 via a ring 65, as is commonly used for a variety of leashes. For example, the leash might use spring-loaded snap hooks including a sliding metal bolt, a trigger to rotate the snap open, or a carabiner style arm that swings open to attach to a ring 65 or direct to the dog's collar 60. The latch or hook 40 preferably includes a swivel so that the leash 10 does not twist up if the dog turns in a circle. At the opposite end, the leash has a handle or a loop 50 where a person can hold the leash. An intermediate section 25 of the leash splits into two separate strands 130 and 140. A front section 20 of the leash spans from the hook 40 at the collar end of the leash to the intermediate section. A rear section 30 of the leash spans from the intermediate section to the handle 50.

The material used to construct the intermediate portion of the leash may be selected from lighter-weight or more flexible material than the material used in the other sections. The intermediate portion of the leash may be elastic such that the portion of the leash encircling the dog's abdomen stretches. By using lighter-weight or more flexible material, the leash remains flexible even though the intermediate portion 25 of the leash uses a double strand of the leash material. The flexibility of the leash, particularly in the intermediate portion 25 of the leash, is an important feature for the comfort of the dog and for the ease of putting the leash on the dog. The flexibility of the leash, however, must be balanced against the need for the leash to remain fastened around the abdomen 95 of the dog 15. In a preferred embodiment, the two separate strands 130 and 140 of the intermediate section 25 of the leash are constructed from a woven web that is one half to three-quarters of an inch wide, while the remainder of the leash is constructed from a one inch wide woven web, as described above.

The length of the leash and the length of each section of the leash are sized according to the size of dog that will wear the leash. The intermediate section 25 of the leash is long enough to accommodate a variety of sizes of dogs, such that the leash 10 can be wrapped around the dog's abdomen 95, regardless of size variations from dog to dog. If the front section 20 of the leash were too short, the leash would tend to wrap around the dog's chest, and would not reap the benefits gained from leashing the dog's abdomen. The rear section 30 of the leash is likewise long enough to wrap around the abdomen of a variety of dogs, while leaving enough of the leash to give the dog reasonable freedom while giving the dog walker sufficient control. In a preferred embodiment, for a middle or large sized dog such as a golden retriever, the front section 20 of the leash is about eight to twelve inches long, the intermediate section 25 of the leash is about twelve to twenty-four inches long, and most preferably about eighteen to twenty-four inches long, and the rear section 30 of the leash is about twenty-four to forty inches long, and most preferably about thirty-two to forty inches long.

The leash is used by attaching the latch or hook 40 to the dog's collar 60, and then wrapping the leash around the dog's abdomen 95. The handle end 50 of the leash passes through a loop formed by the two strands 130 and 140 in the intermediate section 25 of the leash. When walking a dog using this leash, the leash constricts the dog's abdomen when the dog pulls on the leash. This design offers improved control over the dog, because most dogs respond quickly to pressure around their abdomen. Dogs that typically pull on their lead can be trained using the leash 10 because they prefer not to be constrained by the leash wrapped around their belly.

Further, because the leash attaches to the dog close to the dog's hind legs 70, the person walking the dog has substantially more leverage over the dog. Dogs tend to have a center of mass near their front legs 80 and maintain their balance through their front legs 80. In contrast to the leash described herein, most existing leashes attach either at the dog's collar 60 or at the dog's chest 90. Some existing leashes attach just in front of the dog's front legs 80, but below the collar 60, in an area at the base 91 of the dog's neck.

The leash 10 is also advantageous because it is simple to install on the dog 15. Rather than forcing the dog to step into a complicated harness, the leash is simply wrapped around the dog and passed through the loop formed in the intermediate section 25 of the leash. The loop formed by the two strands 130 and 140 acts to keep the leash positioned around the dog's abdomen 95 and generally prevents the leash from sliding up the dog's body to the chest area 90. The loop also keeps the dog from slipping out of the leash during ordinary walking or jogging.

The leash can alternatively be used just like an ordinary leash, solely attached to the dog's collar 60, in the event that the person does not need extra control over the animal. This is a substantial advantage over many prior art harnesses, which are useless if not installed correctly.

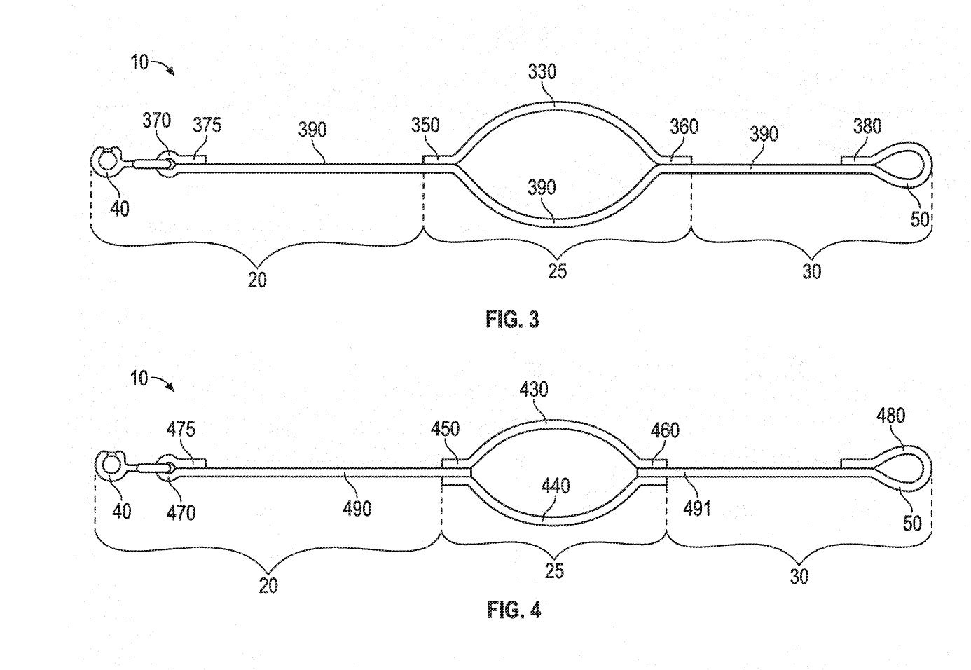

FIG. 3 illustrates one embodiment of the leash, in which a single strand 390 runs the length of the leash 10. An intermediate section 25 of the leash 10 is formed by an additional strand 330, which is bonded to the strand 390 at each end of the intermediate section. At the collar end of the intermediate section, a bond 350 holds a first end of the intermediate strand 330 to the strand 390. At the handle end of the intermediate section, a bond 360 holds the handle end of the intermediate strand 330 to the strand 390. A loop 370 is formed at the collar end of the leash 10 by wrapping the strand 390 around the base of the hook 40. A bond 375 attaches the end of the strand 390 to itself to form the loop 370. At the handle end of the leash, the strand 390 forms a similar bond 380 to itself to form the handle 50. The bonds 350, 360, 375, and 380 may be stitched, glued, fused, crimped, or otherwise attached to one another in a permanent fashion.

FIG. 4 illustrates another embodiment of the leash, in which the front section 20 and rear section 30 are each made from single strands, 490 and 491, respectively. An intermediate section of the leash 10 is formed by two separate strands 430 and 440, which form a bond 450 with the strand 490 at the collar side of the intermediate section and which form a bond 460 with the strand 491 at the handle side of the intermediate section. A loop 470 is formed at the collar end of the leash 10 by wrapping the strand 490 around the base of the hook 40. A bond 475 attaches the end of the strand 490 to itself to form the loop 470. At the handle end of the leash, the strand 491 forms a similar bond 480 to itself to form the handle 50. The bonds 450, 460, 475, and 480 may be stitched, glued, fused, crimped, or otherwise attached to one another in a permanent fashion.

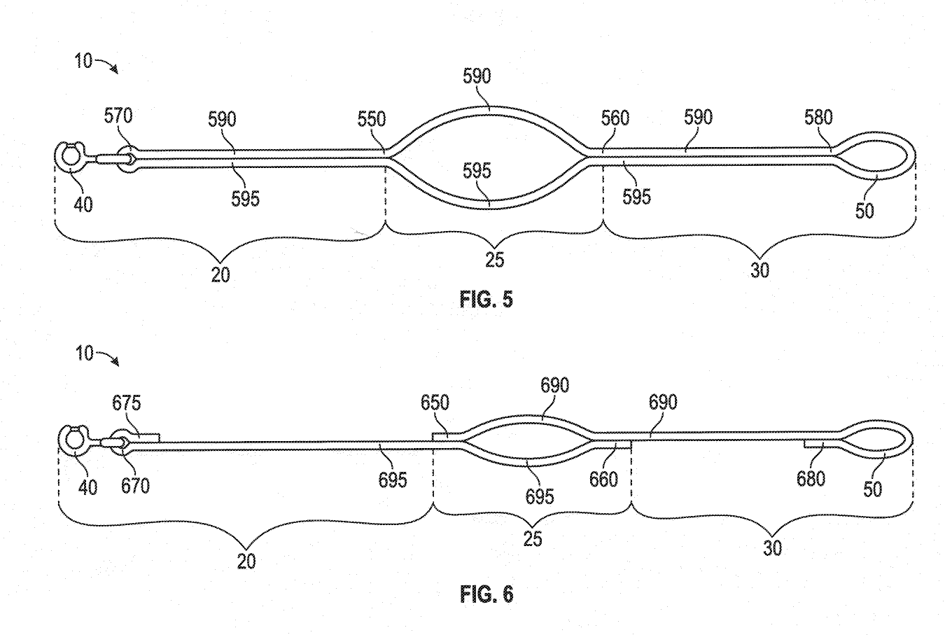

FIG. 5 illustrates still another embodiment of the leash, in which two strands 590 and 595 run the length of the leash 10, and are selectively bonded or joined together in the front section 20 and rear section 30 of the leash 10. The leash 10 includes an intermediate portion 25 illustrated by the separated strands 590 and 595 in which the strands are not bonded. The intermediate portion 25 of the leash 10 forms a loop between the strands 590 and 595, the loop being large enough to pass the handle 50 of the leash. A loop 570 is formed at the collar end of the leash such that the leash wraps around the hook 40. A second loop forms the handle 50 of the leash 10. The strands 590 and 595 are bonded together from the loop 570 to the collar end 550 of the intermediate section to form the front section 20 of the leash 10. Similarly, the strands 590 and 595 are bonded together from the from the handle end 560 of the intermediate section 25 to handle end 580 of the rear section 30. The first strand 590 and the second strand 595 may be stitched together, glued, fused, crimped, or otherwise attached to one another in a permanent fashion within the front section 20 and the rear section 30.

FIG. 6 illustrates still another embodiment of the leash, in which one strand 690 makes up the rear section 30 of the leash 10, and another strand 695 makes up the front section 20 of the leash 10. The leash 10 includes an intermediate portion 25 made up of both the front strand 695 and the rear strand 690. The intermediate portion 25 of the leash 10 forms a loop between the strands 690 and 695, the loop being large enough to pass the handle 50 of the leash. The end of the front strand 695 forms a bond 660 with the rear strand 690 at the handle end of the intermediate section 25. Similarly, the end of the rear strand 690 forms a bond 650 with the front strand 695 at the collar side of the intermediate section 25. A loop 670 is formed at the collar end of the leash such that the leash wraps around the hook 40. A bond 675 attaches the end of the strand 695 to itself to form the loop 670. At the handle end of the leash, the rear strand 690 forms a similar bond 680 to itself to form the handle 50. The bonds 650, 660, 675, and 680 may be stitched, glued, fused, crimped, or otherwise attached to one another in a permanent fashion.

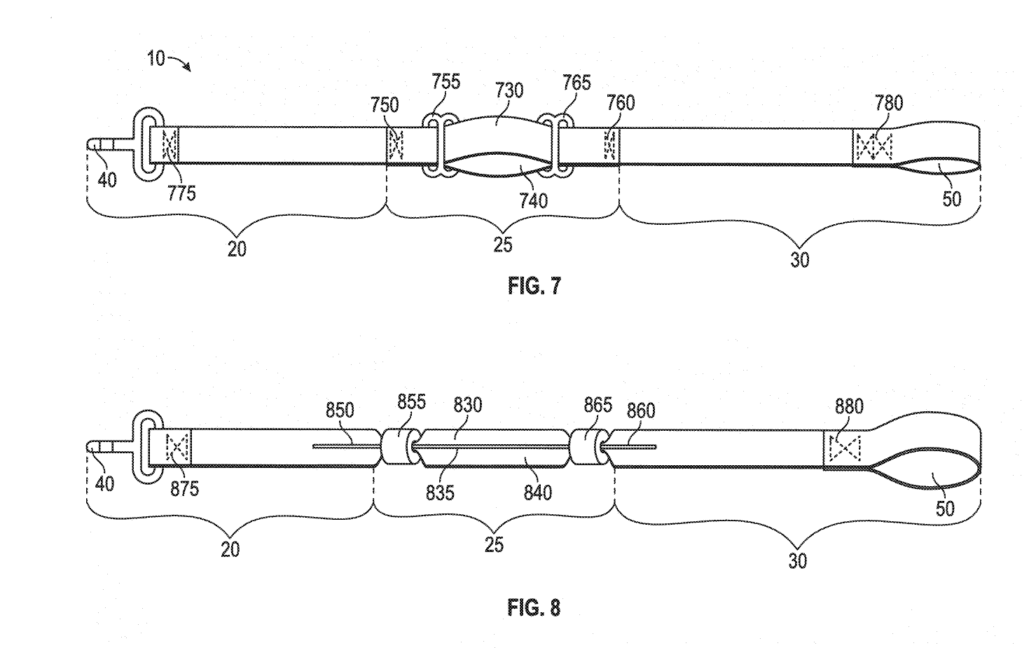

FIG. 7 illustrates an embodiment of the leash with rings 755 and 665 that adjust the length of the intermediate section formed by the strands 730 and 740. The rings 755 and 765 comprise three-bar slides, which can be moved to various positions along the length of the leash 10 when there is no tension on the leash. A variety of other devices could be used to adjust the size of the intermediate section, including a metal band that encircles the leash, a rectangular ring, or a variety of strap adjusters and quick release mechanisms. The rings 755 and 765 improve the fit of the leash 10 to a given dog 15 by adjusting the size and position of the intermediate section of the leash so that it fits above the dog's abdomen 95. The rings 755 and 765 make adjusting the fit of the leash intuitive because they allow the user of the lease to separately adjust both ends of the intermediate portion of the leash. FIG. 7 further illustrates bonds 775, 750, 760, and 780 that are stitched, glued, fused, crimped or otherwise attach the leash to itself in a permanent fashion.

FIG. 8 illustrates an embodiment of the leash formed from a single piece of webbing, which has a split 835 in the intermediate section 25. The split 835 may be formed by cutting the body of the leash 10, or if the leash is formed from webbing it may be woven into the webbing of the leash 10. As in the other illustrations, the leash 10 may be constructed in whole or in part from an elastic material such that the leash stretches when pulled upon. In particular, the intermediate portion of the leash may be elastic such that the portion of the leash encircling the dog's abdomen stretches.

Stoppers 855 and 865 adjust the length of the intermediate section 25 formed by the strands 855 and 865. The stoppers 855 and 865 are molded from rubber or plastic or be a metal ring coated with rubber or plastic. The stoppers 855 and 865 may be cylindrical as shown, or rectangular. Each stopper 855 and 865 includes a through-hole sized large enough to fit the leash, but small enough to prevent the stopper from moving freely along the length of the leash. The rubber or plastic material tends to prevent sliding of the stopper along the length of the leash because it grips the leash. Thus, the stoppers 855 and 865 are slidable on the length of the leash 10 for the purpose of adjusting the length or placement of the intermediate section 25, but remain fixed in place during use of the leash. As illustrated in FIG. 8, the stoppers 855 and 865 constrict the leash at least somewhat. At the handle end 860 of the split 835 extends beyond the stopper 865, although the stopper may also be positioned beyond the handle end 860 of the split. Likewise, the collar end 850 of the split 835 is shown extending beyond the stopper 855, although the stopper 855 may also be positioned closer to the collar end of the leash.

FIG. 8 further illustrates bonds 875 that form a loop to secure the hook 40 and the bond 880 that forms a handle 50. As in the other illustrations, the bonds 875 and 880 may be stitched, glued, fused, crimped or otherwise attach the end of the leash to itself in a permanent fashion to create a loop.

Slides designed to adjust the ends of the intermediate section 25, such as the rings 755 and 765 illustrated in FIG. 7 and the stoppers 855 and 865 illustrated in FIG. 8, improve the fit of the leash 10 to a given dog 15 by adjusting the size and position of the intermediate section 25 of the leash 10 so that it fits above the dog's abdomen 95. Known harnesses do not offer adjustment to keep the leash positioned properly above the abdomen of the dog. Alternatively, known harnesses are adjustable but the adjustment cannot be fixed along the length of the leash. Existing leashes are known to pass the handle of a leash through a single ring, the position of which may be adjusted along the length of the leash. By instead providing a leash with two separate strands, the disclosed leash provides a larger opening through which the handle of the leash may be passed when fitting the leash to a dog. Further, the slides allow the user of the leash to reduce the size of the intermediate portion of the leash after the leash is fitted to the dog.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. This will also be understood to encompass various combinations and permutations of the various components that have been set forth in these teachings.

1. A leash for an animal, the leash comprising:
a single flexible web;
a collar end formed from a loop of the flexible web that captures a mechanism for attaching the leash to a collar on the neck of the animal;
a handle end formed from a loop of the flexible web and positioned opposite the collar end;
an intermediate loop located between the collar end of the leash and the handle end of the leash, the intermediate loop formed from two lengths of the flexible web;
a front section spanning from the collar end of the leash to a collar end of the intermediate loop, the front section comprising two front section strands of the flexible web bonded together along the length of the front section;
a rear section comprising a rear strand of the flexible web spanning from a handle end of the intermediate loop to the handle end of the leash;
wherein the leash is configured to encircle the animal's abdomen by passing the handle end of the leash through the intermediate loop such that the leash forms a constrictive loop around the animal's abdomen; and
wherein the front section has a length configured such that when the leash encircles the animal's abdomen a portion of the intermediate loop is configured to lie substantially adjacent to the animal's abdomen.

2. The leash of claim 1, the rear section further comprising:
a portion of the flexible web bonded to the rear strand of the flexible web at the handle end of the intermediate loop; and
a portion of the flexible web bonded to the rear strand of the flexible web at the handle end of the rear section;

3. The leash of claim 1, wherein the length of the front section is eight to twelve inches.

4. The leash of claim 1, wherein the length from the collar end of the intermediate loop to the handle end of the intermediate loop is twelve to twenty-four inches.

5. The leash of claim 1, wherein the length from the collar end of the intermediate loop to the handle end of the intermediate loop is eighteen to twenty-four inches.

6. The leash of claim 1, further comprising:
at least one slide selectively positioned along the leash such that the slide, when positioned over the intermediate loop of the leash, is configured to size the leash for use with a particular size of animal.

7. The leash of claim 6, wherein the two lengths of the flexible web forming the intermediate loop pass through the at least one slide.

8. A leash for an animal, the leash comprising:
a single flexible web;
a collar end formed from a loop of the flexible web that captures a mechanism for attaching the leash to a collar on the neck of the animal;
a handle end formed from a loop of the flexible web and positioned opposite the collar end;
an intermediate loop located between the collar end of the leash and the handle end of the leash, the intermediate loop formed from two lengths of the flexible web;
a rear section spanning from the handle end of the leash to a handle end of the intermediate loop, the rear section comprising two rear section strands of the flexible web bonded together along the length of the rear section;
a front section comprising a front strand of the flexible web spanning from a collar end of the intermediate loop to the collar end of the leash;
wherein the leash is configured to encircle the animal's abdomen by passing the handle end of the leash through the intermediate loop such that the leash forms a constrictive loop around the animal's abdomen; and
wherein the front section has a length configured such that when the leash encircles the animal's abdomen a portion of the intermediate loop is configured to lie substantially adjacent to the animal's abdomen.

9. The leash of claim 8, the front section further comprising:
a portion of the flexible web bonded to the front strand of the flexible web at the collar end of the intermediate loop;
a portion of the flexible web bonded to the front strand of the flexible web at the collar end of the front section;

10. The leash of claim 8, wherein the length of the front section is eight to twelve inches.

11. The leash of claim 8, wherein the length from the collar end of the intermediate loop to the handle end of the intermediate loop is twelve to twenty-four inches.

12. The leash of claim 8, wherein the length from the collar end of the intermediate loop to the handle end of the intermediate loop is eighteen to twenty-four inches.

13. The leash of claim 8, further comprising:
at least one slide selectively positioned along the leash such that the slide, when positioned over the intermediate loop of the leash, is configured to size the leash for use with a particular size of animal.

14. The leash of claim 13, wherein the two lengths of the flexible web forming the intermediate loop pass through the at least one slide.
